(19) United States
(12) Patent Application Publication
(10) Pub. No.: US 2018/0174151 A1
(43) Pub. Date: Jun. 21, 2018

(54) SYSTEMS, METHODS, AND MEDIA FOR APPLYING REMOTE DATA USING A BIOMETRIC SIGNATURE SAMPLE

(71) Applicants: Synergex Group, Greenwich, CT (US); Wayne Taylor, Chandler, AZ (US); Pham Holdings, Inc., Lacey, WA (US)

(72) Inventor: Thien Van Pham, Lacey, WA (US)

(73) Assignees: Synergex Group, Greenwich, CT (US); Wayne Taylor, Chandler, AZ (US); Pham Holdings Inc., Lacey, WA (US)

(21) Appl. No.: 15/845,987

(22) Filed: Dec. 18, 2017

Related U.S. Application Data
(63) Continuation-in-part of application No. 15/382,710, filed on Dec. 18, 2016.

(51) Int. Cl. G06Q 20/40; H04L 29/06; G06Q 20/34

(52) U.S. Cl. CPC G06Q 20/40145; G06Q 20/34; H04L 63/0861

(57) ABSTRACT

Systems, methods, and media for applying remote data using a biometric signature sample are provided. In some embodiments, systems for applying remote data using a biometric signature sample are provided, the systems comprising: a storage device for storing remote data; at least one hardware processor in communication with the storage device that is configure to: receiving a biometric signature sample; validating the biometric signature sample; receiving the remote data associated with the biometric signature sample from the storage device; applying the remote data; and logging the application of the remote data.

### CROSS-REFERENCE TO RELATED APPLICATION

This application is a continuation-in-part of U.S. patent application Ser. No. 15/382,710, filed Dec. 18, 2016, which is hereby incorporated by reference herein in its entirety.

### BACKGROUND

In light of ever-increasing numbers of security breaches, requiring users to provide security credentials to validate their identity and/or authorization to perform some action is critical. Unfortunately, however, it is very unnatural for a person to remember a user name and password this is not easily broken. For example, a user name that is just the person's name and a password that is just the name the person's child can easily be compromised.

Accordingly, new mechanisms for securely and easily providing data for use in an application are desirable.

### SUMMARY

Systems, methods, and media for applying remote data using a biometric signature sample are provided. In some embodiments, systems for applying remote data using a biometric signature sample are provided, the systems comprising: a storage device for storing remote data; at least one hardware processor in communication with the storage device that is configure to: receiving a biometric signature sample; validating the biometric signature sample; receiving the remote data associated with the biometric signature sample from the storage device; applying the remote data; and logging the application of the remote data.

In some embodiments, methods for applying remote data using a biometric signature sample are provided, the methods comprising: storing remote data in a storage device; receiving a biometric signature sample at a hardware processor; validating the biometric signature sample; receiving the remote data associated with the biometric signature sample from the storage device; applying the remote data; and logging the application of the remote data.

In some embodiments, non-transitory computer-readable media containing computer executable instructions that, when executed by a processor, cause the processor to perform a method for applying remote data using a biometric signature sample are provided, the method comprising: storing remote data in a storage device; receiving a biometric signature sample; validating the biometric signature sample; receiving the remote data associated with the biometric signature sample from the storage device; applying the remote data; and logging the application of the remote data.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates an example of a process for applying remote data using a biometric signature sample in accordance with some embodiments.

FIG. 2 illustrates an example of a system for applying remote data using a biometric signature sample in accordance with some embodiments.

FIG. 3 illustrates an example of hardware that can be used in one or more of the components of FIGS. 2 and 6 in accordance with some embodiments.

FIG. 4 illustrates an example of a user interface that may be presented prior to initiating a process as shown in FIG. 5 in accordance with some embodiments.

FIG. 5 illustrates a more specific example of a process for applying remote data using a biometric signature sample in accordance with some embodiments.

FIG. 6 illustrates a more specific example of a system for applying remote data using a biometric signature sample in accordance with some embodiments.

### DETAILED DESCRIPTION

Various embodiments are now described in detail with reference to the accompanying drawings. In the following description, numerous specific details are set forth in order to provide thorough understanding of the present disclosure. It should be apparent to one skilled in the art, however, that the present disclosure may be practiced without some or all of these specific details. In some instances, well known process steps and/or structures have not been described in detail in order not to unnecessarily obscure the present disclosure. In addition, while the disclosure is described in conjunction with particular embodiments, it should be understood that this description is not intended to limit the disclosure to the described embodiments. To the contrary, the description is intended to cover alternatives, modifications, and equivalents as may be included within the spirit and scope of the invention as defined by the appended claims.

In accordance with various embodiments, mechanisms, which can include systems, methods, and media, for applying remote data using a biometric signature sample are provided in accordance with some embodiments.

In some embodiments, a biometric signature sample can be used to access remote data so that remote data can be used for some application. For example, in some embodiments, a biometric signature can be entered on a device, validated by a remote server, used to retrieve credentials from a data server, and applied to perform a security function.

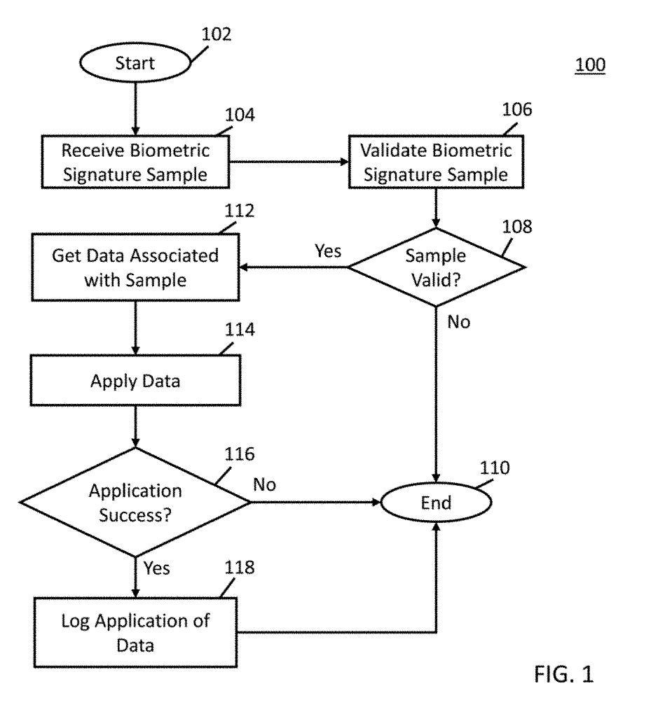

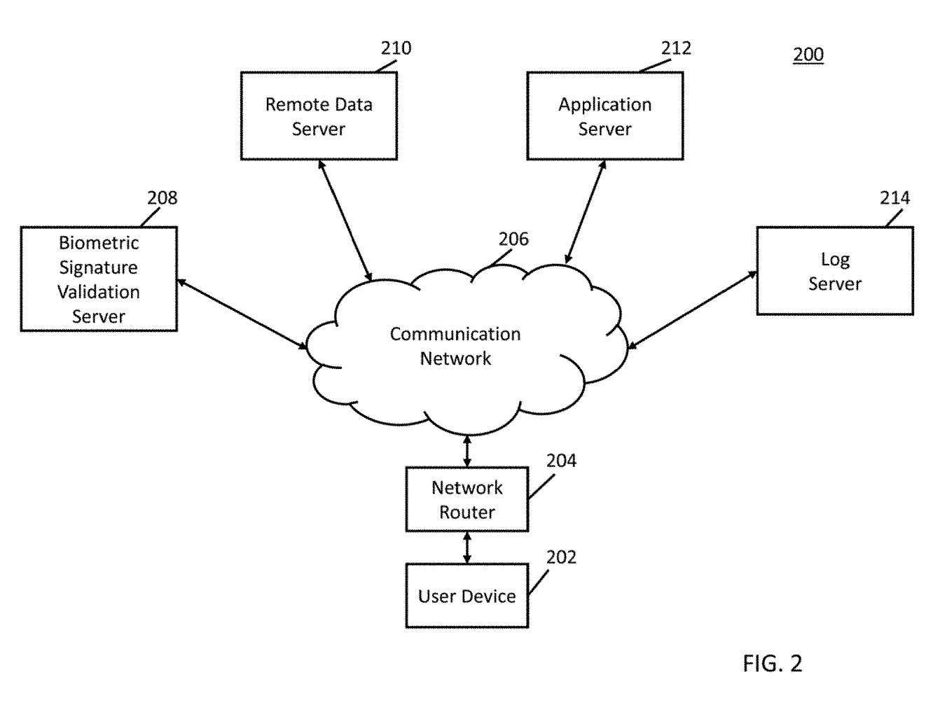

Turning to FIG. 1, an example 100 of a process for applying remote data using a biometric signature sample in accordance with some embodiments is shown. Process 100 can be executed by any suitable one or more devices. For example, in some embodiments, portions of process 100 can be performed by different components shown in FIG. 2, described below. In some embodiments, process 100 can be performed by a subset (including only one (e.g., the user device, the biometric signature validation server, or the application server)) of the components shown in FIG. 2.

As illustrated, after process 100 begins at 102, the process receives a biometric signature sample at 102. A biometric signature sample can be any suitable signature for identifying a user that is based on the user's physiology. For example, in some embodiments, a biometric signature sample can be any suitable data, such as data based on an image or video of a face, audio of a voice, a finger print, a hand-written signature (e.g., drawn by the movement of a computer mouse, finger on a touch screen or digitizer tablet, etc.), in some embodiments. The biometric signature sample can be received in any suitable manner. For example, in some embodiments, the biometric signature sample can be received at a touch screen interface of a user device in response to a user signing on the touch screen interface using the user's index finger. As another example, in some embodiments, the biometric signature sample can be received from the user device at a biometric signature validation server or an application server (see FIG. 2 described below).

Next, at 106, the biometric signature sample can be validated. In some embodiments, a biometric signature sample can be validated in any suitable manner. For example, in some embodiments, a biometric signature sample can be validated by comparing it to a reference and determining if it is suitably similar. More particularly, for example, a biometric signature sample can be determined to be valid if it matches 90% (or any suitable numbers) of a set of features of the reference, in some embodiments. The biometric signature sample can be validated by a biometric signature validation server (see FIG. 2 described below) in some embodiments.

At 108, it can be determined if the biometric signature sample is valid. If it is determined that the sample is not valid, process 100 can branch to and end at 110. Otherwise, if it is determined that the sample is valid, process 100 can branch to 112. The determination of whether the biometric signature sample is valid can be made by a biometric signature validation server (see FIG. 2 described below) or by another component based on data from the biometric signature validation server, in some embodiments.

At 112, process 100 can get remote data associated with the biometric signature sample at 112. This data can be obtained in any suitable manner by any suitable component from any suitable source, in some embodiments. For example, in some embodiments, this data can be obtained by a biometric signature validation server from a remote data server (see FIG. 2 described below). As another example, this data can be obtained by a user device from a remote data server (see FIG. 2 described below), by a remote data server from itself (see FIG. 2 described below), or by an application server from a remote data server (see FIG. 2 described below), based on data from the biometric signature validation server (see FIG. 2 described below) in some embodiments.

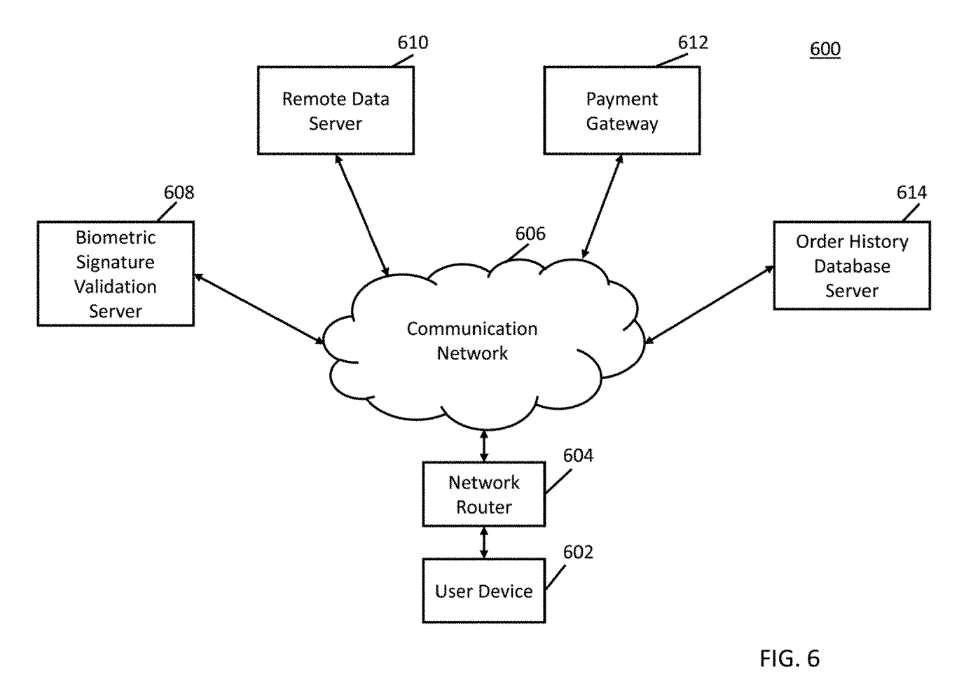

Next, at 114, the remote data can be applied. This data can be applied in any suitable manner. For example, in some embodiments, this data can be applied as described in the examples provided below. This data can be applied by any suitable component. For example, in some embodiments, this data can be applied by an application server (see FIG. 2 described below), which can be implemented to perform a specific function (e.g., like payment gateway 612 of FIG. 6).

At 116, it can be determined if the application of the remote data was successful. If it is determined that the application was not successful, process 100 can branch to and end at 110. Otherwise, if it is determined that the application was successful, process 100 can branch to 118. The determination of whether the application of the remoted data was successful can be made by an application server (see FIG. 2 described below) or by another component based on data from the application server in some embodiments.

At 118, process 100 can log data relating to the application of the remote data. Any suitable data can be logged in some embodiments. For example, in some embodiments, data including a user id, a user device id, an IP address of the user device (which may be an IP address of a router to which the user device is connected), a biometric signature sample id, a remote data id, an application id, an application instance id, a time, a date, and/or any other suitable data can be logged. Logging of data at 118 can be performed by any suitable component in some embodiments. For example, data can be logged by a log server (see FIG. 2 described below) or by another component which sends the data to the log server in some embodiments.

FIG. 2 illustrates an example 200 of a system in which the mechanisms described herein can be implemented. As shown, system 200 includes a user device 202, a network router 204, a communication network 206, a biometric signature validation server 208, a remote data server 210, and an application server 212, and a log server 214.

Although a single user device is shown in FIG. 2, any suitable number of user devices can be used in some embodiments. Although four separate servers are shown in FIG. 2, any suitable number of servers can be used in some embodiments. For example, two or more of the servers shown in FIG. 2 can be combined so that their functions are performed on a single server. Although a single router is shown in FIG. 2, any suitable number of routers (including none) can be used in some embodiments. Although only a single communication network is shown in FIG. 2, any suitable number of communication networks can be used in some embodiments.

User device 202 can be any suitable device from which a user can enter a biometric signature sample to apply remote data in some embodiments. For example, in some embodiments, user device 202 can be a mobile phone (e.g., a smart phone), a computer (e.g., a laptop computer, a desktop computer, a tablet computer, etc.), a smart appliance (e.g., a smart refrigerator), a vehicle (e.g., car, boat, plane, motorcycle, etc.) navigation, entertainment, or information system, an entertainment system (e.g., a set-top box, a streaming media device, a smart speaker, a television, etc.), a media capture device (e.g., a still image camera, a video camera, an audio recording device, etc.) and/or any other suitable device.

Network router 204 can be any suitable device for connecting one or more user devices 202 to one or more networks 206 in some embodiments. Network router can be a wired router and/or a wireless router, in some embodiments. For example, in some embodiments, network router 204 can be a WiFi router.

Communication network 206 can be any suitable communication network in some embodiments. Communication network 206 can include any suitable sub-networks, and network 206 and any one or more of the sub-networks can include any suitable connections (e.g., wires, cables, fiber optics, wireless links, etc.) and any suitable equipment (e.g., routers, gateways, switches, firewalls, receivers, transmitters, transceivers, etc.), in some embodiments. For example, network 206 can include the Internet, cable television networks, satellite networks, telephone networks, wired networks, wireless networks, local area networks, wide area networks, Ethernet networks, WiFi networks, mesh networks, and/or any other suitable networks.

Biometric signature validation server 208 can be any suitable server for validating a biometric signature sample in some embodiments. As described above, a biometric signature sample can be any suitable signature for identifying a user that is based on the user's physiology. For example, in some embodiments, a biometric signature sample can be any suitable data, such as data based on an image or video of a face, audio of a voice, a finger print, a hand-written signature (e.g., drawn by the movement of a computer mouse, finger on a touch screen or digitizer tablet, etc.), in some embodiments. As also described above, in some embodiments, a biometric signature sample can be validated in any suitable manner. For example, in some embodiments, a biometric signature sample can be validated by comparing it to a reference and determining if it is suitably similar. More particularly, for example, a biometric signature sample can be determined to be valid if it matches 90% (or any suitable numbers) of a set of features of the reference, in some embodiments.

Remote data server 210 can be any suitable server for storing remote data in some embodiments. The remote data can be any suitable data useful for an application, as described further below, in some embodiments. For example, in some embodiment, remote data can security credentials, personal information (e.g., name, address, date of birth, social security number, etc.), payment information (e.g., credit card number, credit card type, account holder, expiration date, security code, billing address, etc.), and/or any other information that may need to be provided to an application only after verifying user authorization to do so.

Application server 212 can be any suitable server for applying remote data from database server 210 in some embodiments. Application server 212 can apply the remote data by performing any suitable application and/or function in some embodiments. For example, in some embodiments, the application server can use remote data to perform a security function (e.g., such as providing access to a web site, an application, a database, a server, a vehicle, etc.), complete a financial transaction (e.g., such as payment for a product or service), acknowledge agreement to something (e.g., agree to the terms of a contract), etc.

Log server 214 can be any suitable server for logging data relating to the application of the remote data by application server 212 in some embodiments. Log server 214 can log any suitable data in some embodiments. For example, in some embodiments, the log server can log data including a user id, a user device id, an IP address of the user device (which may be an IP address of a router to which the user device is connected), a biometric signature sample id, a remote data id, an application id, an application instance id, a time, a date, and/or any other suitable data.

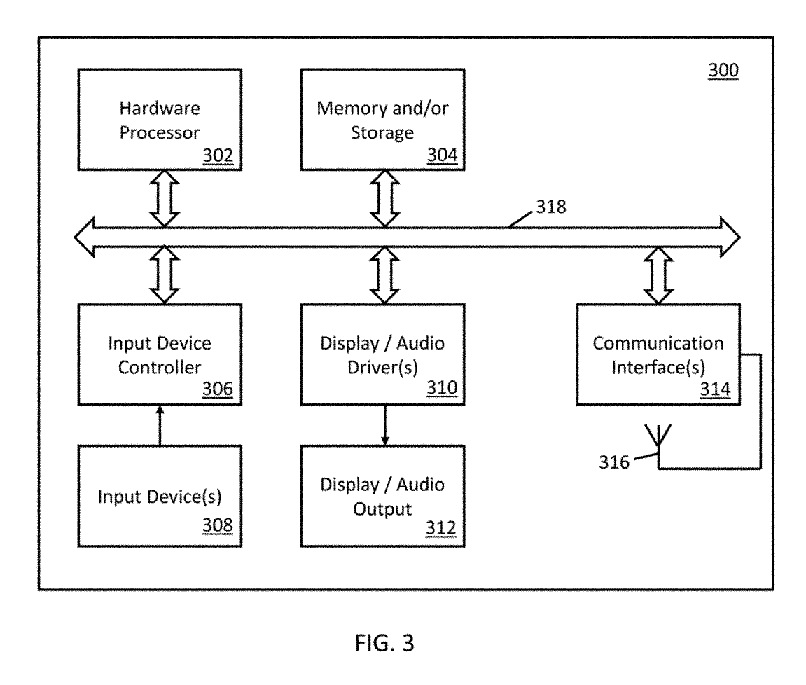

User device 202 and servers 208, 210, 212, and 214 can be implemented using any suitable hardware in some embodiments. For example, in some embodiments, any one or more of user device 202 and servers 208, 210, 212, and 214 can be implemented using any suitable general-purpose computer or special-purpose computer. For example, user device 202 can be implemented using a special-purpose computer, such as a smart phone. Any such general-purpose computer or special-purpose computer can include any suitable hardware. For example, as illustrated in example hardware 300 of FIG. 3, such hardware can include a hardware processor 302, memory and/or storage 304, an input device controller 306, input device(s) 308, display/audio driver(s) 310, display and audio output circuitry 312, communication interface(s) 314, an antenna 316, and a bus 318.

Hardware processor 302 can include any suitable hardware processor, such as a microprocessor, a micro-controller, digital signal processor(s), dedicated logic, and/or any other suitable circuitry for controlling the functioning of a general-purpose computer or a special-purpose computer in some embodiments.

Memory and/or storage 304 can be any suitable memory and/or storage for storing programs, data, media content, and/or any other suitable information in some embodiments. For example, memory and/or storage 304 can include random-access memory, read-only memory, flash memory, hard disk storage, optical media, and/or any other suitable memory.

Input device controller 306 can be any suitable circuitry for controlling and receiving input from a device, such as input device(s) 308, in some embodiments. For example, input device controller 306 can be circuitry for receiving input from an input device 308, such as a touch screen, from one or more buttons, from a voice recognition circuit, from a microphone, from a camera, from an optical sensor, from an accelerometer, from a temperature sensor, from a near field sensor, and/or any other type of input device.

Display/audio driver(s) 310 can be any suitable circuitry for controlling and driving output to one or more display/audio output circuitries 312 in some embodiments. For example, display/audio driver(s) 310 can be circuitry for driving an LCD display, a speaker, an LED, or any other type of output device.

Communication interface(s) 314 can be any suitable circuitry for interfacing with one or more other devices and/or communication networks, such as network 206 as shown in FIG. 2. For example, interface(s) 314 can include network interface card circuitry, wireless communication circuitry, and/or any other suitable type of communication network circuitry.

Antenna 316 can be any suitable one or more antennas for wirelessly communicating with a communication network in some embodiments. In some embodiments, antenna 316 can be omitted when not needed.

Bus 318 can be any suitable mechanism for communicating between two or more components 302, 304, 306, 310, and 314 in some embodiments.

Any other suitable components can be included in hardware 300 in accordance with some embodiments.

As described above, in response to validating a biometric signature sample, a remote data can be accessed and an application performed using that remote data. Any suitable application can be performed in some embodiments. For example, in some embodiments, remote data from a server can be used to authenticate a user and start the user's car, open the user's car doors, unlock the user's house doors, disable the user's car and/or home security system, turn on or off home security cameras, gain access to security camera footage. As another example, in some embodiments, remote data from a server can be used to indicate that a user agrees to pay for something, to provide information about a user (e.g., name, address, date of birth, social security number, etc.), to agree to an agreement (e.g., contract), etc.

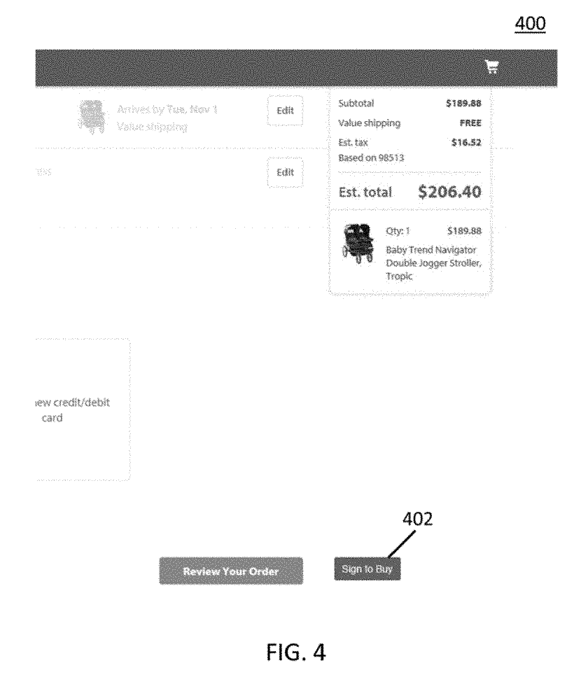

As a more particular example, in some embodiments, the techniques described herein can be used to complete an online purchase of a product or service. For example, when purchasing a product, a user may be presented with an option to sign to pay for the purchase. More particularly, an interface like interface 400 of FIG. 4 can be presented in some embodiments and can include a button 402 that enables a user to select to sign to buy a product.

In response to a user selecting to sign to buy, a mechanism to receive a biometric signature sample can be initiated. When the biometric signature sample is a hand-written signature, a user interface can be presented on a user device to receive the hand-written signature. For example, a screen on a user device can present a box in which the user can sign the user's signature using the user's finger (when the screen is touch sensitive), a stylus (when the screen is sensitive to a stylus), using any other suitable pointer, etc. Once the signature has been entered, the signature, which is a biometric signature sample, can be validated as described above. Once the biometric signature sample is successfully validated, the user's default credit card information can be retrieved from remote storage. Once the credit card information has been retrieved, the credit card information can be used to complete the purchase. If the credit card information is successfully processed, a transaction ID, the biometric signature sample, order information, and/or any other suitable data can be logged.

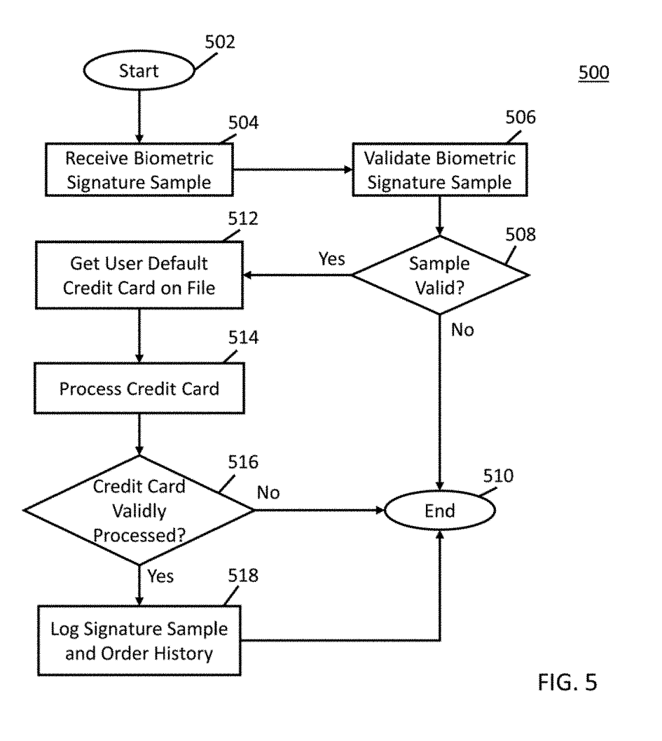

Turning to FIGS. 5 and 6, examples 500 and 600 of a process and a system, respectively, that can be used to implement a sign-to-buy mechanism in accordance with some embodiments are shown.

As illustrated, after process 500 begins at 502, the process requests at 504 that the user sign his/her signature using a movement of the user's finger, stylus, or computer mouse using user device 602. Once the signature sample is collected, the process causes the biometric signature sample to be provided to biometric signature validation server 608 from user device 602 via network router 604 and network 606, and causes the signature sample to be validated by biometric signature validation server 608 at 506. If the biometric signature sample collected is determined to not be valid, at 508, process 500 branches to 510 and terminates. Otherwise, at 508, the process branches to 512 and retrieves default credit card information in remote data server 610. At 514, process 500 provides the credit card information to payment gateway 612, which attempts to process the credit card information to complete the purchase. At 516, process 500 determines if the credit card payment was validly processed. If not, process 500 branches to 510 and terminates. Otherwise, process 500 branches to 518 and stores the biometric signature sample collected, a user identifier, an order identifier, a transaction ID, and/or any other suitable information in order history database server 614. After storing the data at 518, process 500 terminates at 510.

The components of system 600 can be implemented as described above for the components of system 200 of FIG. 2 in some embodiments. More particularly, components 602, 604, 606, 608, 610, 612, and 614 can be implemented as described above for components 202, 204, 206, 208, 210, 212, and 214 of FIG. 2 in some embodiments. Payment gateway 612 can be a specific form of application server 212 (in that it performs a specific function), and order history database server 614 can be a specific form of log server 214 (in that it logs certain types of data), in some embodiments.

Processes 100 and 500 describe communication between various components. This communication can be performed in any suitable manner in some embodiments. For example, in some embodiments, for each communication, a connection can be established between the components, data transmitted, and the connection broken. As another example, in some embodiments, connections between components can remain established for multiple communication instances.

It should be understood that at least some of the above described blocks of the processes of FIGS. 1 and 5 can be executed or performed in any order or sequence not limited to the order and sequence shown in and described in the figures. Also, some of the above blocks of the processes of FIGS. 1 and 5 can be executed or performed substantially simultaneously where appropriate or in parallel to reduce latency and processing times. Additionally or alternatively, some of the above described blocks of the processes of FIGS. 1 and 5 can be omitted.

In some implementations, any suitable computer readable media can be used for storing instructions for performing the functions and/or processes described herein. For example, in some implementations, computer readable media can be transitory or non-transitory. For example, non-transitory computer readable media can include media such as non-transitory forms of magnetic media (such as hard disks, floppy disks, etc.), non-transitory forms of optical media (such as compact discs, digital video discs, Blu-ray discs, etc.), non-transitory forms of semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for applying remote data using a biometric signature sample, comprising:
a storage device for storing remote data;
at least one hardware processor in communication with the storage device that is configure to:
receiving a biometric signature sample;
validating the biometric signature sample;
receiving the remote data associated with the biometric signature sample from the storage device;
applying the remote data; and
logging the application of the remote data.

2. The system of claim 1, wherein the biometric signature sample is a hand-written signature.

3. The system of claim 1, wherein the biometric signature sample is captured on a user device.

4. The system of claim 1, wherein the biometric signature sample is validated by comparing it to a reference.

5. The system of claim 1, wherein applying the remote data comprises performing a function using the remote data.

6. The system of claim 1, wherein the function is completing a purchase of a product.

7. The system of claim 1, wherein the completing of the purchase of a product is performed by providing credit card information to a payment gateway.

8. A method for applying remote data using a biometric signature sample, comprising:
storing remote data in a storage device;
receiving a biometric signature sample at a hardware processor;
validating the biometric signature sample;
receiving the remote data associated with the biometric signature sample from the storage device;
applying the remote data; and
logging the application of the remote data.

9. The method of claim 8, wherein the biometric signature sample is a hand-written signature.

10. The method of claim 8, wherein the biometric signature sample is captured on a user device.

11. The method of claim 8, wherein the biometric signature sample is validated by comparing it to a reference.

12. The method of claim 8, wherein applying the remote data comprises performing a function using the remote data.

13. The method of claim 8, wherein the function is completing a purchase of a product.

14. The method of claim 8, wherein the completing of the purchase of a product is performed by providing credit card information to a payment gateway.

15. A non-transitory computer-readable medium containing computer executable instructions that, when executed by a processor, cause the processor to perform a method for applying remote data using a biometric signature sample, the method comprising:
storing remote data in a storage device;
receiving a biometric signature sample;
validating the biometric signature sample;
receiving the remote data associated with the biometric signature sample from the storage device;
applying the remote data; and
logging the application of the remote data.

16. The non-transitory computer readable medium of claim 15, wherein the biometric signature sample is a hand-written signature.

17. The non-transitory computer readable medium of claim 15, wherein the biometric signature sample is captured on a user device.

18. The non-transitory computer readable medium of claim 15, wherein the biometric signature sample is validated by comparing it to a reference.

19. The non-transitory computer readable medium of claim 15, wherein applying the remote data comprises performing a function using the remote data.

20. The non-transitory computer readable medium of claim 15, wherein the function is completing a purchase of a product.

21. The non-transitory computer readable medium of claim 15, wherein the completing of the purchase of a product is performed by providing credit card information to a payment gateway.
